(19) United States
(12) Patent Application Publication
(10) Pub. No.: US 2017/0139537 A1
(43) Pub. Date: May 18, 2017

(54) SYSTEM AND METHOD FOR DETERMINING A NUMBER OF USERS AND THEIR RESPECTIVE POSITIONS RELATIVE TO A DEVICE

(71) Applicant: Intel Corporation, Santa Clara, CA (US)

(72) Inventors: Raghvendra Maloo, Bangalore (IN); Gokul V. Subramaniam, Bangalore (IN)

(73) Assignee: Intel Corporation, Santa Clara, CA (US)

(21) Appl. No.: 15/300,667

(22) PCT Filed: May 13, 2015
(86) PCT No.: PCT/US2015/030443

§ 371 Date: Sep. 29, 2016

(30) Foreign Application Priority Data
Jun. 1, 2014 (IN) 2682/CHE/2014

(51) Int. Cl. G06F 3/041

(52) U.S. Cl. CPC G06F 3/0418; G06F 2203/04104

(57) ABSTRACT

Particular embodiments described herein provide for a system, an apparatus, and a method for determining a number of users and their respective positions relative to a device. One example embodiment includes acquiring touch point data from a hand of a user, clustering the touch point data, and determining a respective position of the user by mapping the clustered touch point data to a pre-defined hand pattern. The touch point data can include a plurality of touch points and a distance between each touch point is used to cluster the touch point data. In one example, the touch point data may be acquired using a touch sensor and the touch sensor can be a touch display.

### FIELD OF THE DISCLOSURE

Embodiments described herein generally relate to the field of electronic devices, and more particularly, to determining a number of users and their respective positions relative to a device.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified block diagram illustrating an embodiment of an electronic device, in accordance with one embodiment of the present disclosure;

FIG. 1B is a simplified block diagram illustrating an embodiment of an electronic device, in accordance with one embodiment of the present disclosure;

FIG. 2 is a simplified block diagram illustrating an embodiment of an electronic device, in accordance with one embodiment of the present disclosure;

FIG. 3 is a simplified block diagram illustrating an embodiment of user identification module, in accordance with one embodiment of the present disclosure;

FIG. 4 is a simplified block diagram illustrating an embodiment of a portion of an electronic device, in accordance with one embodiment of the present disclosure;

FIG. 5 is a simplified block diagram illustrating an embodiment of a portion of an electronic device, in accordance with one embodiment of the present disclosure;

FIG. 6 is a simplified block diagram illustrating an embodiment of a portion of an electronic device, in accordance with one embodiment of the present disclosure;

FIG. 7 is a simplified block diagram illustrating an embodiment of a portion of an electronic device, in accordance with one embodiment of the present disclosure;

FIG. 8 is a simplified block diagram illustrating an embodiment of a portion of an electronic device, in accordance with one embodiment of the present disclosure;

FIG. 9 is a simplified flowchart illustrating potential operations that may be associated with one embodiment of the present disclosure;

FIG. 10 is a simplified flowchart illustrating potential operations that may be associated with one embodiment of the present disclosure;

FIG. 11 is a simplified block diagram associated with an example ARM ecosystem system on chip (SOC) of the present disclosure; and

FIG. 12 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF THE EMBODIMENTS

### Overview

In an example, there is disclosed a system, an apparatus, and a method for determining a number of users and their respective positions relative to a device. One example embodiment includes acquiring touch point data from a hand of a user, clustering the touch point data, and determining a respective position of the user by mapping the clustered touch point data to a pre-defined hand pattern. The touch point data can include a plurality of touch points and a distance between each touch point is used to cluster the touch point data. In one example, the touch point data may be acquired using a touch sensor and the touch sensor can be a touch display.

In addition, a touch point clustering module may be used to cluster the touch point data. The clustered touch point data can be re-configured when a finger touch point is classified as a thumb touch point. Further, the clustered touch point data may be prevented from being mapped to more than one hand pattern using a pattern conflict resolution module where the pattern conflict resolution module uses a horizontal span and a vertical span to determine the correct hand pattern. Hand geometric statistics can be used to remove false positives from the clustered touch point data.

### EXAMPLE EMBODIMENTS OF THE DISCLOSURE

Large screen devices like adaptive all-in-ones or big tablets are featured to be used as a multi-user device and can be used in the tabletop mode allowing a user to lay the system completely flat on a tabletop or other surface. These capabilities allow users to use the system for multi-user gaming, shared art, browsing, content creation, presentation applications and if required the system can be used as a lay flat surface. Supporting these usages has various challenges. Sometimes it can be difficult to know the number of users playing a multi-user game. Also, in a tabletop mode, a user can be positioned at any of the four sides of the surface and it can be difficult to know a user's current position in order to orientation the display accordingly. Currently, in multi-user games, users explicitly specify the number of players through the application user interface. Similarly, in table-top mode, user explicitly adjust the device orientation using control panel functions. Current solutions take the required parameters (position and count) from each user explicitly through some application user interface (UI) with multiple and monotonous steps. What is needed is a system and method that allows for a device to identify the number of users and their positions around the device by having the user do only a few simple steps. It would be beneficial if the system could automatically determine the number of users and their positions.

The foregoing is offered by way of non-limiting examples in which the system and method of the present specification may usefully be deployed. The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiment many have different advantages, and no particular advantage is necessarily required of any embodiment.

In the examples of the present specification, a system and method can be provided that allows for an electronic device to identify the number of users and their positions around a device by having the user do only a few simple steps and then the system automatically determines the number of users and their positions. This allows the system to avoid the multiple initial setup steps typically required and hence makes the overall system faster and easier to operate. The system can provide a user experience that is more intuitive, elegant, and faster than existing solutions and does not take the required parameters (position and count) from each user explicitly through some application UI with multiple and monotonous steps. In an example, the system can be configured to automatically determine the number of users and their respective positions around a device by having each user perform a multi-finger touch on the device.

The multi-finger touch can be a pre-define touch gesture that can be analyzed to determine the number of users and their respective positions. The pre-defined touch gesture can be almost any type of multi-finger touch by the user. In a specific example, the most natural and conflict-free touch gesture is for a user to put their hand on a display and hold it on the display for few milliseconds (ms) (e.g., about 200 ms to about 1500 ms). The pre-define touch gesture data can be processed in a hardware accelerated (e.g., graphics processing unit-acceleration units (GPU-EUs)) environment for a real-time or near real time response. In other example, the processing can be slower.

The processing of the touch point data can be done in a GPU. A touch point clustering phase clusters touch points in different subgroups based on their shortest distance from each other. A thumb position correction phase can include is correction logic where the system considers the fact that the thumb and index fingers of a user are too close and their position on the horizontal axis should be reordered in order to match pre-defined hand patterns. A hand pattern matching (e.g., geometric recognition) phase maps each of the subgroups to possible hand patterns. For example, on a square display, the system may have four possible hand patterns, one for each side of the display. A pattern conflict resolution phase considers various other parameters like horizontal span and vertical span of the cluster to determine the most appropriate mapped pattern for the subgroup. A false positive removal phase can remove false positives by using various hand geometric statistics and comparing the geometric statistics with corresponding values of the current touch point subgroup.

Output of the touch point data processing is a hand count that represents the number of users and the orientation of each hand with respect to the device. From the orientation of each hand with respect to the device, a suggested user's position around the device can be determined. The output of the touch processing is made available to multi-user applications and background services through a user's touch software development kit (SDK) to enable various use cases.

The system can be configured to provide a new user experience of interacting with the system through a hand touch gesture to indicate the presence of the user around the system. The system can be touch hardware, operating system (OS), application software stack agnostic and can be ported to almost any platform. The processing of the touch gesture data can be done using a touch points clustering algorithm to identify a number of hands and the algorithm can detect hand orientation in n*log(n) time complexity (where “n” is the number of users). Various phases of the touch point clustering and hand orientation detection algorithms can be implemented into GPU-EUs for hardware accelerated response and for Pre-OS secure application usage possibilities (e.g. High-Definition Multimedia Interface (HDMI) TV contents).

In an example, users place their hands on a touch screen. A touch sensor sends the raw touch data to a touch driver. The touch driver can pass the data to a graphics driver through a private interface and memory map. The graphics driver initiates touch kernel processing in GPU-EUs using the touch input data. Touch kernel processing passes the touch input through the various phases including touch point clustering, thumb position correction, hand pattern matching, conflict resolution, and false positive removal. Output of this step is a hand count and the orientation of each hand. Once output of the touch kernel processing is available, it propagates to a user mode component of a user's touch SDK. User's touch SDK further sends notifications to the registered processes to take further appropriate actions accordingly.

### Example Embodiments

The following detailed description sets forth example embodiments of apparatuses, methods, and systems relating to detection of display rotation mechanisms or devices for an electronic device. Features such as structure(s), function(s), and/or characteristic(s), for example, are described with reference to one embodiment as a matter of convenience; various embodiments may be implemented with any suitable one or more of the described features.

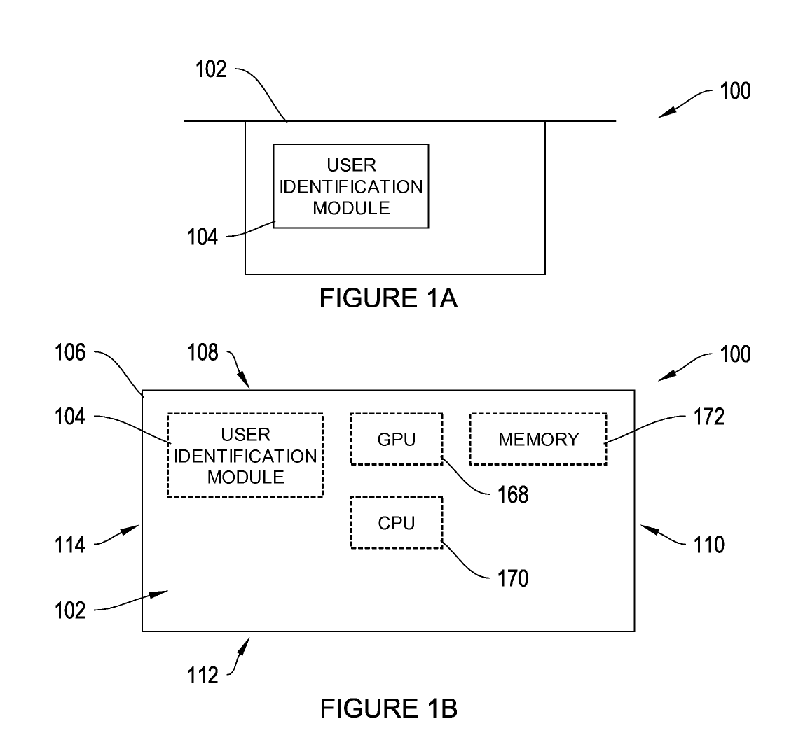

FIG. 1A is a simplified block diagram illustrating an embodiment of an electronic device 100 configured for determining a number of users and their respective positions relative to a device in accordance with one embodiment of the present disclosure. In an example, electronic device 100 is an adaptive all-in-ones or big tablet, however, electronic device 100 can be any device that can facilitate the system and methods discussed herein. Electronic device 100 can include a surface 102 and a user identification module 104.

Turning to FIG. 1B, FIG. 1B is a simplified block diagram illustrating an embodiment of electronic device 100 in accordance with one embodiment of the present disclosure. Electronic device 100 may include user identification module 104, a display 106, a first side 108, a second side 110, a third side 112, a fourth side 114, one or more GPUs 168, one or more processors 170, and memory 172.

Display 106 may be a liquid crystal display (LCD) display screen, a light-emitting diode (LED) display screen, an organic light-emitting diode (OLED) display screen, a plasma display screen, or any other suitable display screen system. In addition, display 106 may be a touch display. Electronic device 100 can include a battery and various electronics (e.g., wireless module (e.g., Wi-Fi module, Bluetooth module, etc.) processor, memory, camera, a microphone, speakers, etc.).

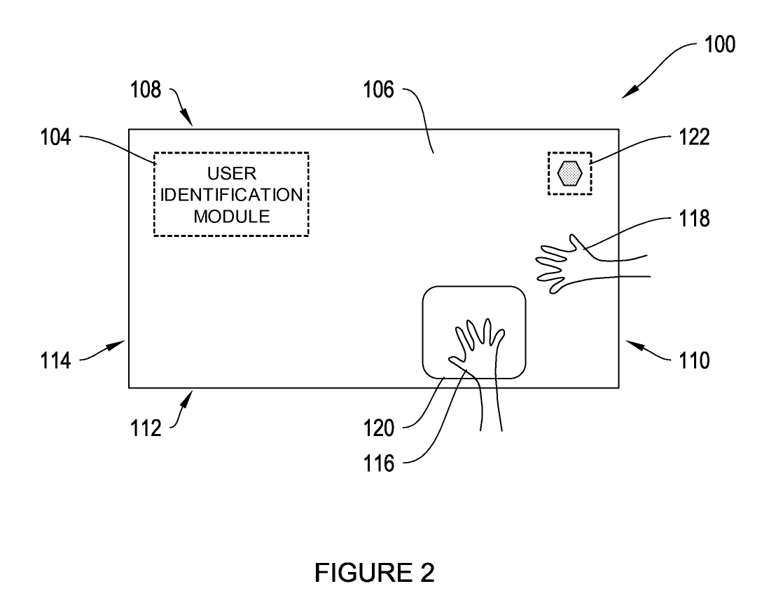

Turning to FIG. 2, FIG. 2 is a simplified block diagram illustrating an embodiment of electronic device 100 in accordance with one embodiment of the present disclosure. As illustrated in FIG. 2, a first user's hand 116 and a second user's hand 118 have been placed on display 106. In an example, display 106 may include a touch sensor 120 where a user can place their hand to identify their presence to electronic device 100. In another example, a user can place their hand anyplace on display 106 to identify the presence of a user to electronic device 100.

By placing first user's hand 116 in touch sensor 120, user identification module 104 can be configured to recognize that a user wants to be identified and user identification module 104 can begin the process of recognizing the presence of the user. In another example, a presence indicator 122 may be selected and presence indicator 122 can signal user identification module 104 that a user wants to be identified and that user identification module 104 should begin the process of recognizing the presence of the user. Touch sensor 120 and/or the touch features of display 106 can detect first user's hand 116 and second user's hand 118 as touch points and user identification module 104 can group the touch points into two subgroups, one for each user.

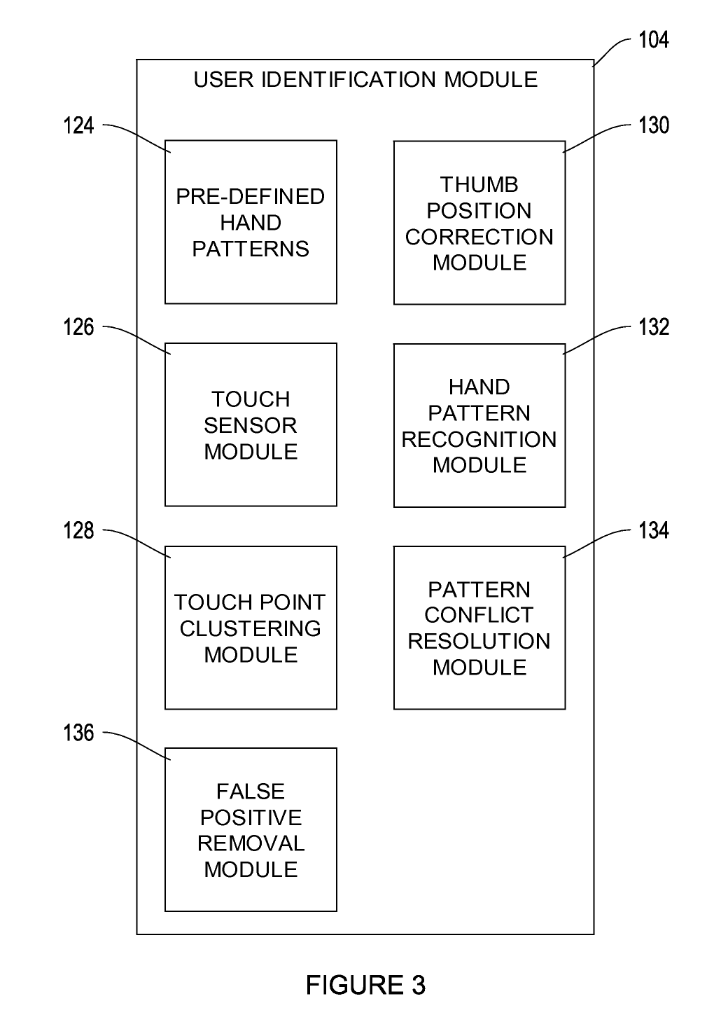

Turning to FIG. 3, FIG. 3 is a simplified block diagram illustrating an embodiment of user identification module 104 in accordance with one embodiment of the present disclosure. User identification module 104 can include pre-defined hand patterns 124, a touch sensor module 126, a touch point clustering module 128, a thumb position correction module 130, a hand pattern recognition module 132, a pattern conflict resolution module 134, and a false positive removal module 136. Pre-defined hand patterns 124 include hand patters that can be used to compare created subgroups of touch points to determine the orientation of a user's hand. Touch sensor module 126 can be configured to recognize when a use's hand has been placed on touch sensor 120, display 106 (if display is a touch display), or presence indicator 122 has been activated. Touch sensor module 126 can acquire touch point data from first user's hand 116 and second user's hand 118.

Touch point clustering module 128 can be configured to clusters the touch point data into different subgroups based on the shortest distance from each of the touch points in the touch point data. Each cluster or subgroup can represent a hand of a user. Thumb position correction module 130 can be configured to correct clustering logic when it determines that thumb and index fingers are too close and their position on a horizontal axis should be reordered in order to match a pre-defined hand pattern in pre-defined hand patterns 124. Thumb position correction module 130 can be configured to be applied to each subgroup individually. Hand pattern matching module 132 can be configured to map each of the subgroups into one of the possible hand patterns in pre-defined hand patterns 124.

It is possible that a subgroup could be mapped to more than one of the possible hand patterns in pre-defined hand patterns 124. Pattern conflict resolution module 134 can resolve the conflict by being configured to consider various other parameters like horizontal span and vertical span of the subgroup to determine the most appropriate mapped pattern for the subgroup. False positive removal module 136 can be configured to use various hand geometric statistics and compare the various hand geometric statistics with a touch point subgroup to remove the false positives. For example, an average vertical distance between various touch points of a subgroup cannot be more than a pre-defined number of inches.

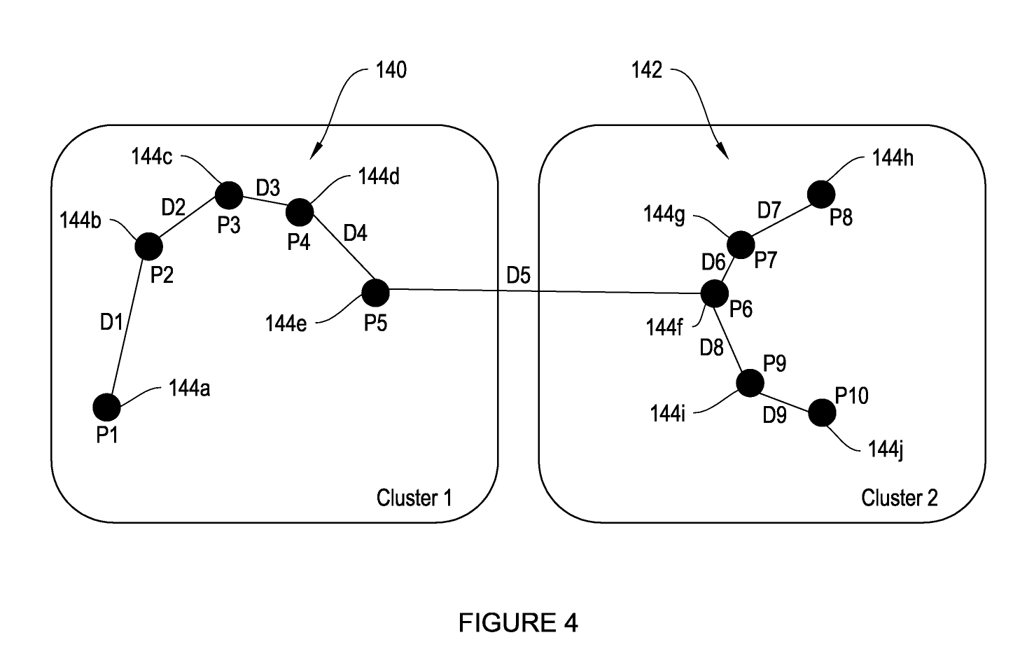

Turning to FIG. 4, FIG. 4 is a simplified block diagram illustrating acquired touch point data in accordance with one embodiment of the present disclosure. First touch point data 140 may have been acquired from first user's hand 116 using touch sensor 120. Second touch point data 142 may have been acquired from second user's hand using display 106. First touch point data 140 and second touch point data 142 are subgroups of the touch points acquired by touch sensor module 126 and created by touch point clustering module 128.

To create first touch point data 140 and second touch point data 142, touch point clustering module 128 can determine the distance between the touch points acquire by touch sensor module 126 and use the distance to separate the touch points into subgroups. Touch point clustering module 128 can be configured to pair touch points 144a-j and calculate the distance between each touch point. For example, touch points 144a and 144b have been paired and the distance between them calculated as D1. Touch points 144b and 144c have been paired and the distance between them calculated as D2. Touch points 144c and 144d have been paired and the distance between them calculated as D3. Touch points 144d and 144e have been paired and the distance between them calculated as D4. Touch points 144e and 144f have been paired and the distance between them calculated as D5. Touch points 144f and 144g have been paired and the distance between them calculated as D6. Touch points 144g and 144h have been paired and the distance between them calculated as D7. Touch points 144f and 144i have been paired and the distance between them calculated as D8. Touch points 144i and 144j have been paired and the distance between them calculated as D9.

Each pair of touch points can be sorted based on the distance between each pair. User identification module 104 can determine the pair of touch points with the largest distance between them and create two subgroups where each subgroup includes one touch point from the pair. For example, as illustrated in FIG. 4, the pair of touch points 144e and 144f have the largest distance between them and each are placed in a subgroup (144e is placed in subgroup 140 and 144f is placed in second touch data point 142).

The pairs of touch points (touch points 144a and 144b, touch points 144b and 144c, etc.) are sorted starting with the least distant pair of touch points and a sub-list is prepared that covers all the points with a minimum distance possible between the points. The process is iterated over this sub-list multiple times to add at least one node to any of the subgroups SG1 and SG2. A node is added to a subgroup if one of the points in a pair is already present in the subgroup. For example, touch point 144d would be added to first touch point data 140 because touch point 144d is paired with touch point 144e. This would cause touch point 144c to be added to first touch point data 140 because touch point 144c is paired with touch point 144d. Touch point 144g would be added to second touch point data 142 because touch point 144g is paired with touch point 144f. The process would continue until each touch point is added to a subgroup. Touch point 144f is paired with 144e but each were made a subgroup because they had the most distance between them of the touch points.

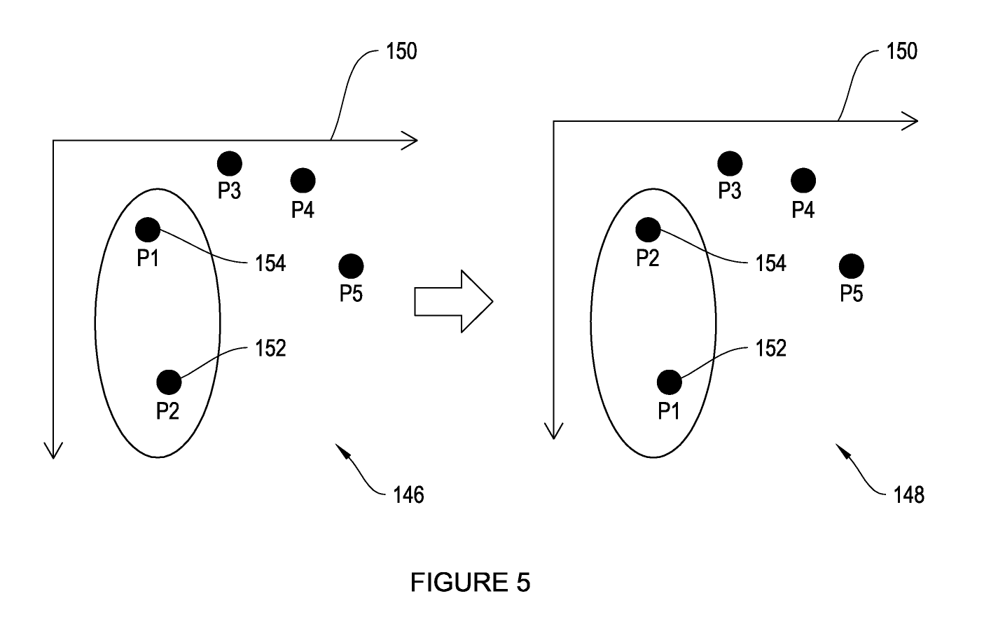

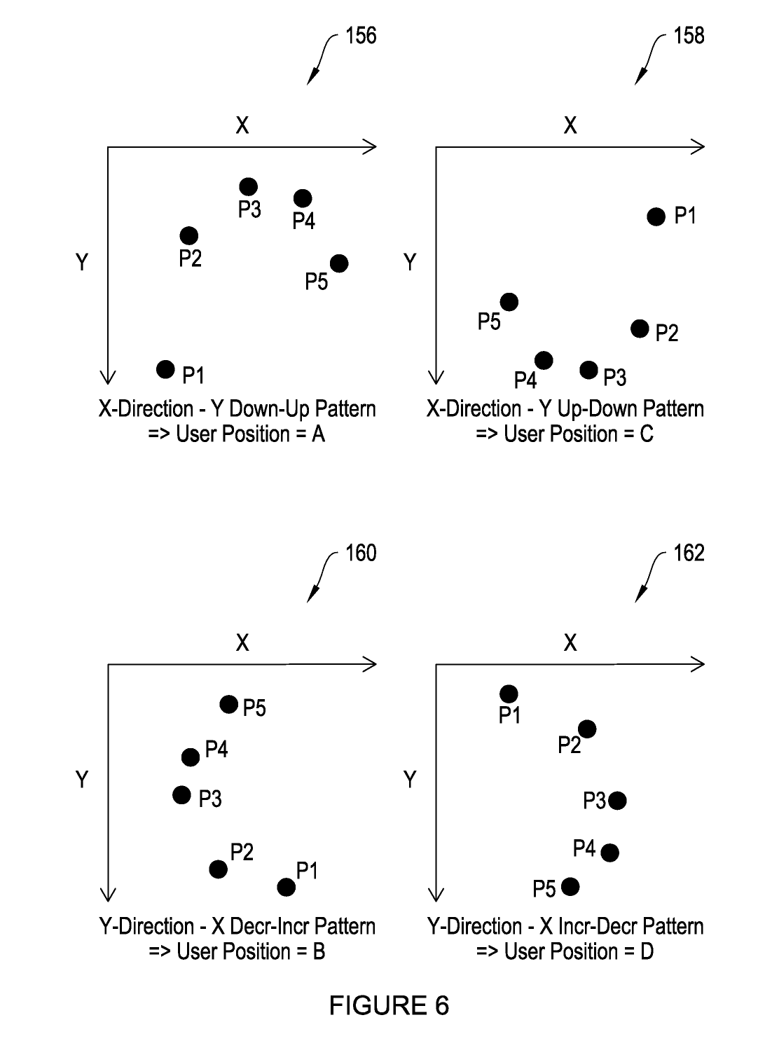

Turning to FIG. 5, FIG. 5 is a simplified block diagram illustrating thumb position correction in accordance with one embodiment of the present disclosure. Thumb position correction module 130 can be configured to correction an instance where a thumb touch point 152 and an index finger touch point 154 are too close. This can cause index finger touch point 154 to be identified as a thumb touch point and thumb touch point 152 to be identified as a finger touch point. This can cause problems because hand pattern recognition module 132 sorts points along one axis (say X-Direction) and looks for Up-Down or Down-Up patterns on the other axis (as explained in FIG. 6). In order to match touch point data similar to the touch point data Illustrated in FIG. 4, their position on a horizontal axis 150 should be reordered. Using this logic, hand pattern recognition module 132 it is able to map a valid touch point cluster to one of the pre-defined hand patterns in pre-defined hand patterns 124.

In some examples, when touch point data is acquired, thumb touch point 152 and index finger touch point 154 are too close and a slight right or left move of their position on horizontal axis 150 can confuse the hand pattern matching logic and not allow a match to be found. FIG. 5 illustrates erroneous touch point data 146 where a slight right move from a normal position of a user's thumb or a slight left move from a normal position of the user's index finger caused an erroneous touch point data 146 pattern as shown and breaks the X Direction-Y Down-Up pattern matching. To allow for proper data matching, index finger touch point 154 is changed to be identified as a finger touch point and thumb touch point 152 is changed to be identified as a thumb touch point to create corrected touch point data 148. Thumb position correction module 130 can be configured to detect a thumb touch point picking the vertical difference of the touch points in a subgroup and the point with the largest vertical difference is the thumb. Thumb position correction module 130 can ensure that the thumb point is at the first of the list being passed to next stage and a proper pattern recognition can be performed.

Turning to FIG. 6, FIG. 6 is a simplified block diagram illustrating hand pattern recognition in accordance with one embodiment of the present disclosure. Hand pattern recognition module 132 can be configured to sort points along one axis (say X-Direction) and try to look for Up-Down or Down-Up pattern on the other axis. Using this process, hand pattern recognition module 132 can map a valid touch point cluster to one of the pre-defined hand patterns in pre-defined hand patterns 124. For example, as illustrated in FIG. 6, pre-defined hand patterns 124 can include a third side touch point data hand pattern 156 to identify a user on third side 112 of electronic device 100, a first side touch point data hand pattern 158 to identify a user on first side 108 of electronic device 100, a second side touch point data hand pattern 160 to identify a user on second side 110 of electronic device 100, and a fourth side touch point data hand pattern 162 to identify a user on fourth side 114 of electronic device 100. In FIG. 6 the term “user position=A” is used to indicate that the user position is on third side 112, the term “user position=C” is used to indicate that the user position is on first side 108, the term “user position=B” is used to indicate that the user position is on second side 110, and the term “user position=D” is used to indicate that the user position is on fourth side 114.

To determine if touch point data (e.g., first touch point data 140) matches third side touch point data hand pattern 156, touch point data on the x-axis is sorted in increasing order and checked to determine if the points follow the Down-Up pattern on the y-axis. To determine if touch point data (e.g., first touch point data 140) matches second side touch point data hand pattern 160, touch point data on the y-axis is sorted in increasing order and checked if the points follow the Down-Up pattern on the x-axis. To determine if touch point data (e.g., first touch point data 140) matches first side touch point data hand pattern 158, touch point data on the x-axis is sorted in increasing order and checked to determine if the points follow the Up-Down pattern on the y-axis. To determine if touch point data (e.g., first touch point data 140) matches fourth side touch point data hand pattern 162, touch point data on the y-axis is sorted in increasing order and check if the points follow the Up-Down pattern on the x-axis

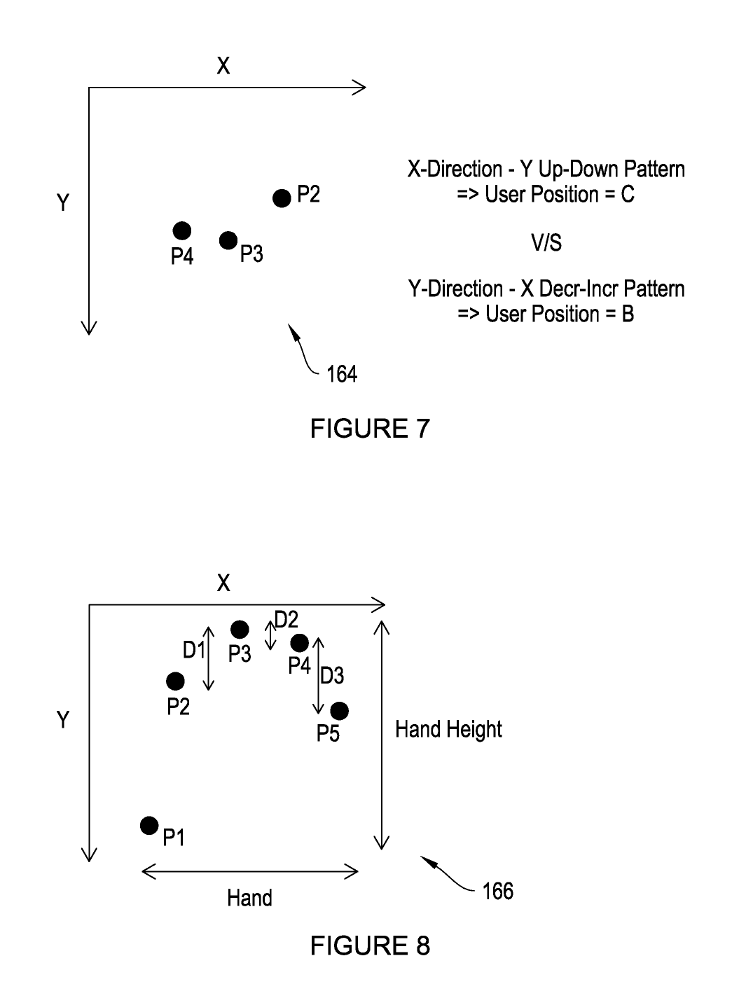

Turning to FIG. 7, FIG. 7 is a simplified block diagram illustrating pattern conflict resolution in accordance with one embodiment of the present disclosure. Pattern conflict module 134 can be configured to resolve conflicts when more than one mapped patterns is created, for example when user is touching with only three or four fingers. As illustrated in FIG. 7, the three touch point data 164 could match first side touch point data hand pattern 158 or it could match second side touch point data hand pattern 160. To resolve such conflicts, pattern conflict module 134 can be configured to take into consideration the x-axis span and y-axis span of three touch point data 164. Because, as illustrated in FIG. 7, the x-axis span is bigger than the y-axis span, pattern conflict module 134 can resolve the conflict and map the cluster to first side touch point data hand pattern 158 and identify a user as being on first side 108.

Turning to FIG. 8, FIG. 8 is a simplified block diagram illustrating false positive removal in accordance with one embodiment of the present disclosure. False positive removal module 136 can be configured to remove false positives which can be generated because of unintentional touches. For example, FIG. 8 illustrates accidental touch point data 166 that was created when a user was using 2 fingers of one hand and 2 fingers of another hand. Though accidental touch point data 166 can form a valid hand pattern is not a valid hand pattern. False positive removal module 136 can remove false positives by considering various hands geometric statistics (e.g. hand width, hand height, average difference of vertical distance between fingers (D1+D2+D3)/3, etc.).

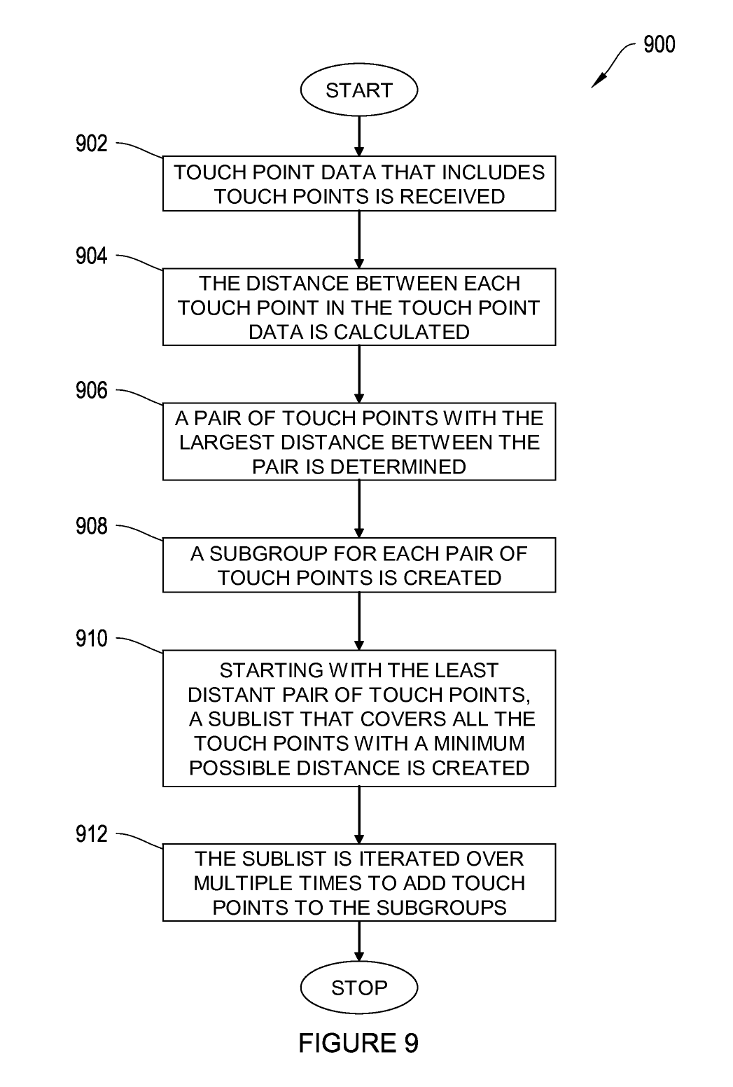

Turning to FIG. 9, FIG. 9 is an example flowchart illustrating possible operations of a flow 900 that may be performed by user identification module 104, in accordance with an embodiment. At 902, touch point data that includes touch points is received. At 904, the distance between each touch point in the touch point data is calculated. At 906, a pair of touch points with the largest distance between the pair is determined. At 908, a subgroup for each pair of touch points is created. At 910, staring with the least distant pair of touch points, a sublist that covers all the touch points with a minimum possible distance is created. At 912, the sublist is iterated over multiple times to add touch points to the subgroups. A touch point is added to a subgroup if the touch point is paired with a touch point that is already in a subgroup.

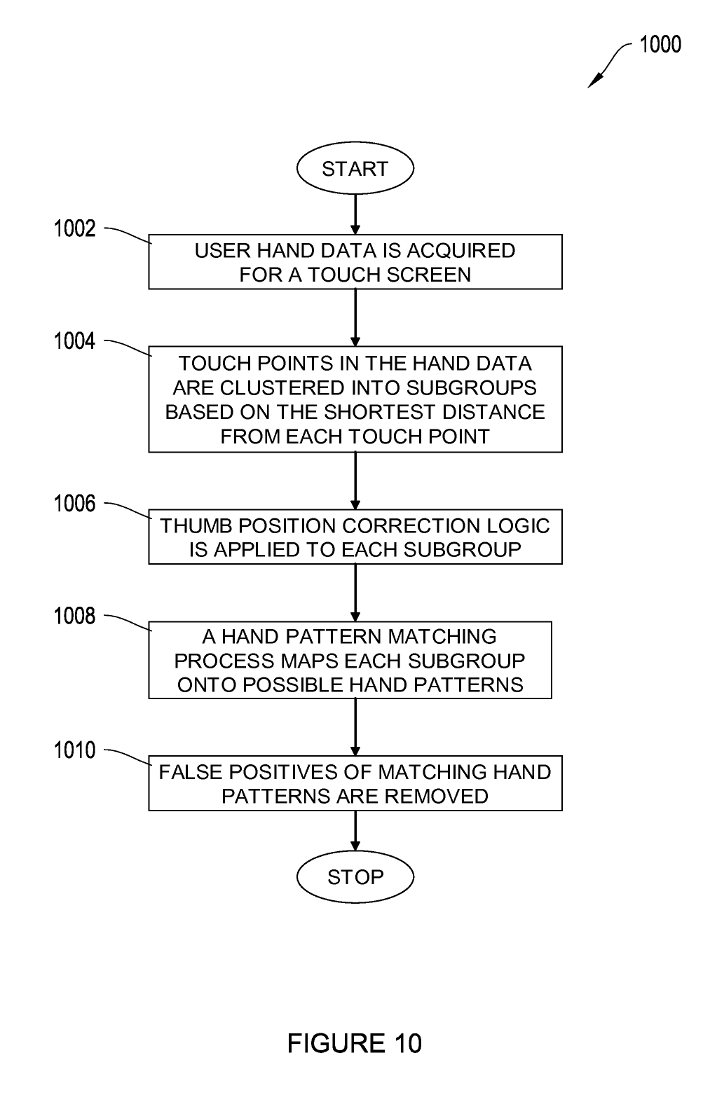

Turning to FIG. 10, FIG. 10 is an example flowchart illustrating possible operations of a flow 1000 that may be performed by user identification module 104, in accordance with an embodiment. At 1002, user hand data is acquired from a touchscreen. At 1004, touch points in the hand data are clustered into subgroups based on the shortest distance from each touch point. At 1006, thumb position correction logic is applied to each subgroup (if needed). At 1008, a hand pattern matching process maps each subgroup onto possible hand patterns. At 1010, false positives of matching hand patterns are removed.

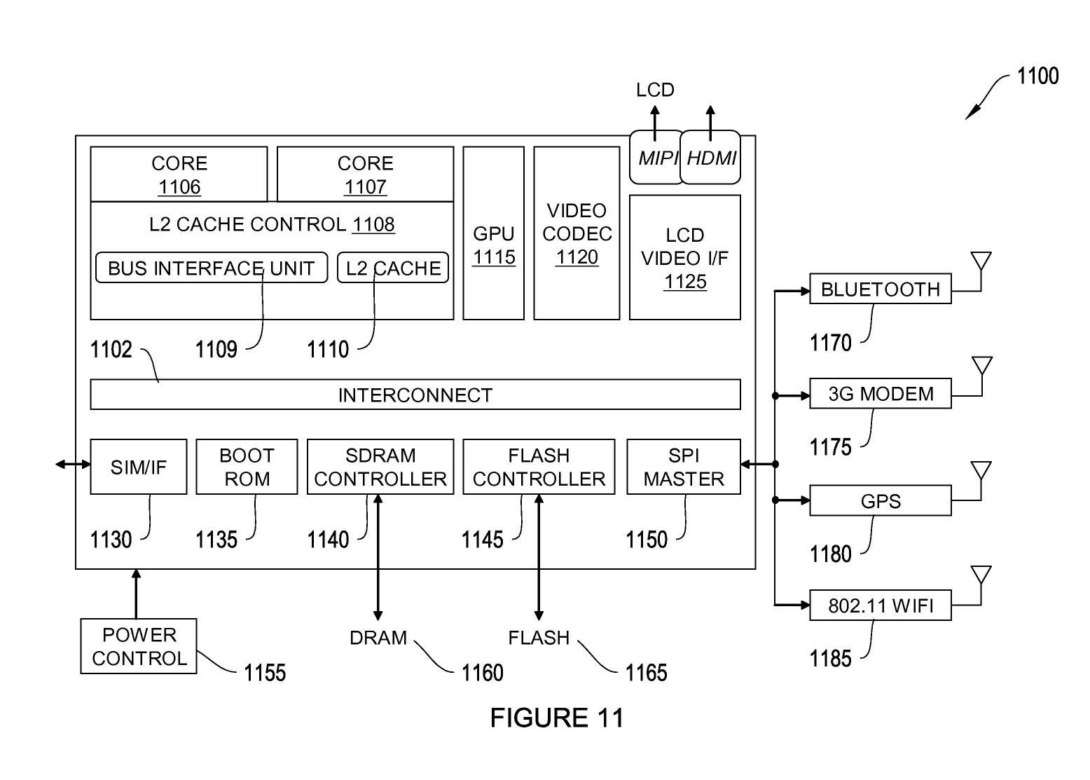

Turning to FIG. 11, FIG. 11 is a simplified block diagram associated with an example ARM ecosystem SOC 1100 of the present disclosure. At least one example implementation of the present disclosure can include an ARM component and the features discussed herein for determining a number of users and their respective positions relative to a device and. For example, the example of FIG. 11 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 11, ARM ecosystem SOC 1100 may include multiple cores 1106-1107, an L2 cache control 1108, a bus interface unit 1109, an L2 cache 1110, a graphics processing unit (GPU) 1115, an interconnect 1102, a video codec 1120, and a liquid crystal display (LCD) I/F 1125, which may be associated with mobile industry processor interface (MIPI)/high-definition multimedia interface (HDMI) links that couple to an LCD.

ARM ecosystem SOC 1100 may also include a subscriber identity module (SIM) I/F 1130, a boot read-only memory (ROM) 1135, a synchronous dynamic random access memory (SDRAM) controller 1140, a flash controller 1145, a serial peripheral interface (SPI) master 1150, a suitable power control 1155, a dynamic RAM (DRAM) 1160, and flash 1165. In addition, one or more example embodiments include one or more communication capabilities, interfaces, and features such as instances of Bluetooth™ 1170, a 3G modem 1175, a global positioning system (GPS) 1180, and an 802.11 Wi-Fi 1185.

In operation, the example of FIG. 11 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

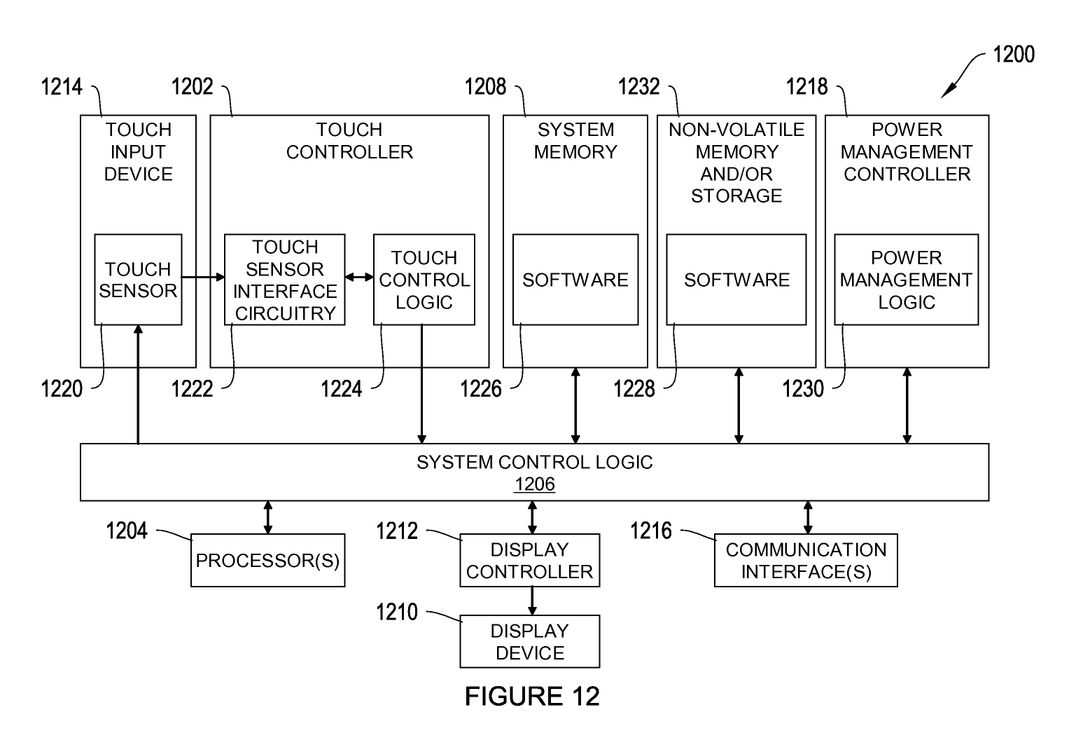

Turning to FIG. 12, FIG. 12 is a simplified block diagram illustrating potential electronics and logic that may be associated with any of the electronic devices discussed herein. In at least one example embodiment, system 1200 can include a touch controller 1202, one or more processors 1204, system control logic 1206 coupled to at least one of processor(s) 1204, system memory 1208 coupled to system control logic 1206, non-volatile memory and/or storage device(s) 1232 coupled to system control logic 1206, display controller 1212 coupled to system control logic 1206, display controller 1212 coupled to a display device 1210, power management controller 1218 coupled to system control logic 1206, and/or communication interfaces 1216 coupled to system control logic 1206.

System control logic 1206, in at least one embodiment, can include any suitable interface controllers to provide for any suitable interface to at least one processor 1204 and/or to any suitable device or component in communication with system control logic 1206. System control logic 1206, in at least one example embodiment, can include one or more memory controllers to provide an interface to system memory 1208. System memory 1208 may be used to load and store data and/or instructions, for example, for system 1200. System memory 1208, in at least one example embodiment, can include any suitable volatile memory, such as suitable dynamic random access memory (DRAM) for example. System control logic 1206, in at least one example embodiment, can include one or more I/O controllers to provide an interface to display device 1210, touch controller 1202, and non-volatile memory and/or storage device(s) 1232.

Non-volatile memory and/or storage device(s) 1232 may be used to store data and/or instructions, for example within software 1228. Non-volatile memory and/or storage device(s) 1232 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 1218 may include power management logic 1230 configured to control various power management and/or power saving functions disclosed herein or any part thereof. In at least one example embodiment, power management controller 1218 is configured to reduce the power consumption of components or devices of system 1200 that may either be operated at reduced power or turned off when the electronic device is in a closed configuration. For example, in at least one example embodiment, when the electronic device is in a closed configuration, power management controller 1218 performs one or more of the following: power down the unused portion of the display and/or any backlight associated therewith; allow one or more of processor(s) 1204 to go to a lower power state if less computing power is required in the closed configuration; and shutdown any devices and/or components that are unused when an electronic device is in the closed configuration.

Communications interface(s) 1216 may provide an interface for system 1200 to communicate over one or more networks and/or with any other suitable device. Communications interface(s) 1216 may include any suitable hardware and/or firmware. Communications interface(s) 1216, in at least one example embodiment, may include, for example, a network adapter, a wireless network adapter, a telephone modem, and/or a wireless modem.

System control logic 1206, in at least one example embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 1204 may be packaged together with logic for one or more controllers of system control logic 1206. In at least one example embodiment, at least one processor 1204 may be packaged together with logic for one or more controllers of system control logic 1206 to form a System in Package (SiP). In at least one example embodiment, at least one processor 1204 may be integrated on the same die with logic for one or more controllers of system control logic 1206. For at least one example embodiment, at least one processor 1204 may be integrated on the same die with logic for one or more controllers of system control logic 1206 to form a System on Chip (SoC).

For touch control, touch controller 1202 may include touch sensor interface circuitry 1222 and touch control logic 1224. Touch sensor interface circuitry 1222 may be coupled to detect touch input over a first touch surface layer and a second touch surface layer of a display (i.e., display device 1210). Touch sensor interface circuitry 1222 may include any suitable circuitry that may depend, for example, at least in part on the touch-sensitive technology used for a touch input device. Touch sensor interface circuitry 1222, in one embodiment, may support any suitable multi-touch technology. Touch sensor interface circuitry 1222, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 1224 may be coupled to help control touch sensor interface circuitry 1222 in any suitable manner to detect touch input over a first touch surface layer and a second touch surface layer. Touch control logic 1224 for at least one example embodiment may also be coupled to output in any suitable manner digital touch input data corresponding to touch input detected by touch sensor interface circuitry 1222. Touch control logic 1224 may be implemented using any suitable logic, including any suitable hardware, firmware, and/or software logic (e.g., non-transitory tangible media), that may depend, for example, at least in part on the circuitry used for touch sensor interface circuitry 1222. Touch control logic 1224 for at least one embodiment may support any suitable multi-touch technology.

Touch control logic 1224 may be coupled to output digital touch input data to system control logic 1206 and/or at least one processor 1204 for processing. At least one processor 1204 for at least one embodiment may execute any suitable software to process digital touch input data output from touch control logic 1224. Suitable software may include, for example, any suitable driver software and/or any suitable application software. As illustrated in FIG. 12, system memory 1208 may store suitable software 1226 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

It is imperative to note that all of the specifications, dimensions, and relationships outlined herein (e.g., height, width, length, materials, etc.) have only been offered for purposes of example and teaching only. Each of these data may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Example Embodiment Implementations

One particular example implementation of an electronic device may include acquiring touch point data from a hand of a user, clustering the touch point data, and determining a respective position of the user by mapping the clustered touch point data to a pre-defined hand pattern. The touch point data can include a plurality of touch points and a distance between each touch point is used to cluster the touch point data. In one example, the touch point data may be acquired using a touch sensor and the touch sensor can be a touch display.

### Other Notes and Examples

Example A1 is an electronic device that includes a touch sensor to acquire touch point data from a hand of a user, a touch point clustering module to cluster the touch point data, and a hand pattern module to determine a respective position of the user by mapping the clustered touch point data to a pre-defined hand pattern.

In Example A2, the subject matter of Example A1 may optionally include where the touch point data includes a plurality of touch points and a distance between each touch point is used to cluster the touch point data.

In Example A3, the subject matter of any of the preceding ‘A’ Examples can optionally include a thumb position correction module to correctly configure the clustered touch point data when a finger touch point is classified as a thumb touch point.

In Example A4, the subject matter of any of the preceding ‘A’ Examples can optionally include a pattern conflict resolution module to help prevent the clustered touch point data from being mapped to more than one hand pattern.

In Example A5, the subject matter of any of the preceding ‘A’ Examples can optionally include where the pattern conflict resolution module uses a horizontal span and a vertical span to determine the correct hand pattern.

In Example A6, the subject matter of any of the preceding ‘A’ Examples can optionally include a false positive removal module to remove false positives.

In Example A7, the subject matter of any of the preceding ‘A’ Examples can optionally include where the false positive removal module uses hand geometric statistics to remove false positives.

In Example A8, the subject matter of any of the preceding ‘A’ Examples can optionally include where the touch point data is received from a touch display.

Example M1 is a method that includes acquiring touch point data from a hand of a user, clustering the touch point data, and determining a respective position of the user by mapping the clustered touch point data to a pre-defined hand pattern.

In Example M2, the subject matter of any of the preceding ‘M’ Examples can optionally include where the touch point data includes a plurality of touch points and a distance between each touch point is used to cluster the touch point data.

In Example M3, the subject matter of any of the preceding ‘M’ Examples can optionally include where the touch point data is acquired using a touch sensor.

In Example M4, the subject matter of any of the preceding ‘M’ Examples can optionally include where the touch sensor is a touch display.

In Example M5, the subject matter of any of the preceding ‘M’ Examples can optionally include where a touch point clustering module is used to cluster the touch point data.

In Example M6, the subject matter of any of the preceding ‘M’ Examples can optionally include re-configuring the clustered touch point data when a finger touch point is classified as a thumb touch point.

In Example M7, the subject matter of any of the preceding ‘M’ Examples can optionally include preventing the clustered touch point data from being mapped to more than one hand pattern using a pattern conflict resolution module.

In Example M8, the subject matter of any of the preceding ‘M’ Examples can optionally include where the pattern conflict resolution module uses a horizontal span and a vertical span to determine the correct hand pattern.

In Example M9, the subject matter of any of the preceding ‘M’ Examples can optionally include removing false positives from the clustered touch point data.

In Example M10, the subject matter of any of the preceding ‘M’ Examples can optionally include using hand geometric statistics to remove false positives from the clustered touch point data.

In Example M11, the subject matter of any of the preceding ‘M’ Examples can optionally include where the first region of interest is a face and the method further includes tracking the face using a facial recognition module as the face moves through the image.

In Example M12, the subject matter of any of the preceding ‘M’ Examples can optionally include where the first region of interest is an object and the method further includes tracking the object using an object recognition module as the object moves through the image.

In Example M13, the subject matter of any of the preceding ‘M’ Examples can optionally include determining a configuration of an electronic device using the angle value.

In Example M14, the subject matter of any of the preceding ‘M’ Examples can optionally include displaying the detected rotation of display portion on a display.

Example C1 is one or more computer readable medium having instructions stored thereon, the instructions, when executed by a processor, cause the processor to acquire touch point data from a hand of a user, cluster the touch point data, wherein the touch point data includes a plurality of touch points and a distance between each touch point is used to cluster the touch point data, and determine a respective position of the user by mapping the clustered touch point data to a pre-defined hand pattern.

In Example C2, the subject matter of any of the preceding ‘C’ Examples can optionally include where the touch point data is acquired using a touch sensor.

Example X1 is a machine-readable storage medium including machine-readable instructions to implement a method or realize an apparatus as in any one of the Examples A1-A8, M1-M14.

Example Y1 is an apparatus comprising means for performing of any of the Example methods M1-M14.

In Example Y2, the subject matter of Example Y1 can optionally include the means for performing the method comprising a processor and a memory. In Example Y3, the subject matter of Example Y2 can optionally include the memory comprising machine-readable instructions.

1. An electronic device, comprising:
a touch sensor to acquire touch point data from a hand of a user;
a touch point clustering module to cluster the touch point data; and
a hand pattern module to determine a respective position of the user by mapping the clustered touch point data to a pre-defined hand pattern.

2. The electronic device of claim 1, wherein the touch point data includes a plurality of touch points and a distance between each touch point is used to cluster the touch point data.

3. The electronic device of claim 1, further comprising:
a thumb position correction module to correctly configure the clustered touch point data when a finger touch point is classified as a thumb touch point.

4. The electronic device of claim 1, further comprising:
a pattern conflict resolution module to help prevent the clustered touch point data from being mapped to more than one hand pattern.

5. The electronic device of claim 4, wherein the pattern conflict resolution module uses a horizontal span and a vertical span to determine the correct hand pattern.

6. The electronic device of claim 1, further comprising:
a false positive removal module to remove false positives.

7. The electronic device of claim 6, wherein the false positive removal module uses hand geometric statistics to remove false positives.

8. The electronic device of claim 1, wherein the touch point data is received from a touch display.

9. A method, comprising:
acquiring touch point data from a hand of a user;
clustering the touch point data; and
determining a respective position of the user by mapping the clustered touch point data to a pre-defined hand pattern.

10. The method of claim 9, wherein the touch point data includes a plurality of touch points and a distance between each touch point is used to cluster the touch point data.

11. The method of claim 9, wherein the touch point data is acquired using a touch sensor.

12. The method of claim 11, wherein the touch sensor is a touch display.

13. The method of claim 9, wherein a touch point clustering module is used to cluster the touch point data.

14. The method of claim 9, further comprising:
re-configuring the clustered touch point data when a finger touch point is classified as a thumb touch point.

15. The method of claim 9, further comprising:
preventing the clustered touch point data from being mapped to more than one hand pattern using a pattern conflict resolution module.

16. The method of claim 15, wherein the pattern conflict resolution module uses a horizontal span and a vertical span to determine the correct hand pattern.

17. The method of claim 9, further comprising:
removing false positives from the clustered touch point data.

18. The method of claim 9, further comprising:
using hand geometric statistics to remove false positives from the clustered touch point data.

19. One or more computer readable medium having instructions stored thereon, the instructions, when executed by a processor, cause the processor to
acquire touch point data from a hand of a user;
cluster the touch point data, wherein the touch point data includes a plurality of touch points and a distance between each touch point is used to cluster the touch point data; and
determine a respective position of the user by mapping the clustered touch point data to a pre-defined hand pattern.

20. The medium of claim 19, wherein the touch point data is acquired using a touch sensor.
